(19) United States
(12) Patent Application Publication
(10) Pub. No.: US 2007/0089254 A1
(43) Pub. Date: Apr. 26, 2007

(54) Drain cleaner guide

(76) Inventor: Trevor Alaine, Beaverton, OR (US)

Correspondence Address: BERKELEY LAW & TECHNOLOGY GROUP, LLP, 1700 NW 167TH PLACE, SUITE 240, BEAVERTON, OR, 97006, US

(21) Appl. No.: 11/257,915

(22) Filed: Oct. 24, 2005

(51) Int. Cl. B08B 9/043

(52) U.S. Cl. 15/104.33

(57) ABSTRACT

Embodiments of methods, apparatuses, devices and systems associated with a drain cleaner guide are disclosed.

### BACKGROUND

Drain cleaners, such as augers and/or snakes, may be used to dislodge and/or remove material that may be at least partially blocking or restricting a lavatory drain and/or other plumbing passageways.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 is a schematic diagram of an embodiment, such as one or more guide components and/or at least in part flexible components;

FIG. 2 is a schematic diagram of an at least in part flexible component operably connected to a powered motor

FIG. 3 is a schematic diagram of the one or more guide components, the at least in part flexible component, and/or a powered motor;

FIG. 4 is a schematic diagram illustrating a usage of an embodiment;

FIG. 5 is a schematic diagram illustrating a usage of an embodiment by a user;

FIG. 6A a schematic diagram of a guide component having one or more opening;

FIG. 6B is a schematic diagram of is a schematic diagram of an at least in part flexible component and an end;

FIGS. 7A and 7B are schematic diagrams of one or more telescoping guide components;

FIG. 8 is a schematic diagram showing one or more removable guide components; and

FIG. 9 is a schematic diagram illustrating a usage of an embodiment.

### DETAILED DESCRIPTION

In the following detailed description, numerous specific details are set forth to provide a thorough understanding of claimed subject matter. However, it will be understood by one of ordinary skill that claimed subject matter may be practiced without these specific details. In other instances, methods, procedures, and/or components that would be understood by one of ordinary skill have not been described in detail so as not to obscure claimed subject matter.

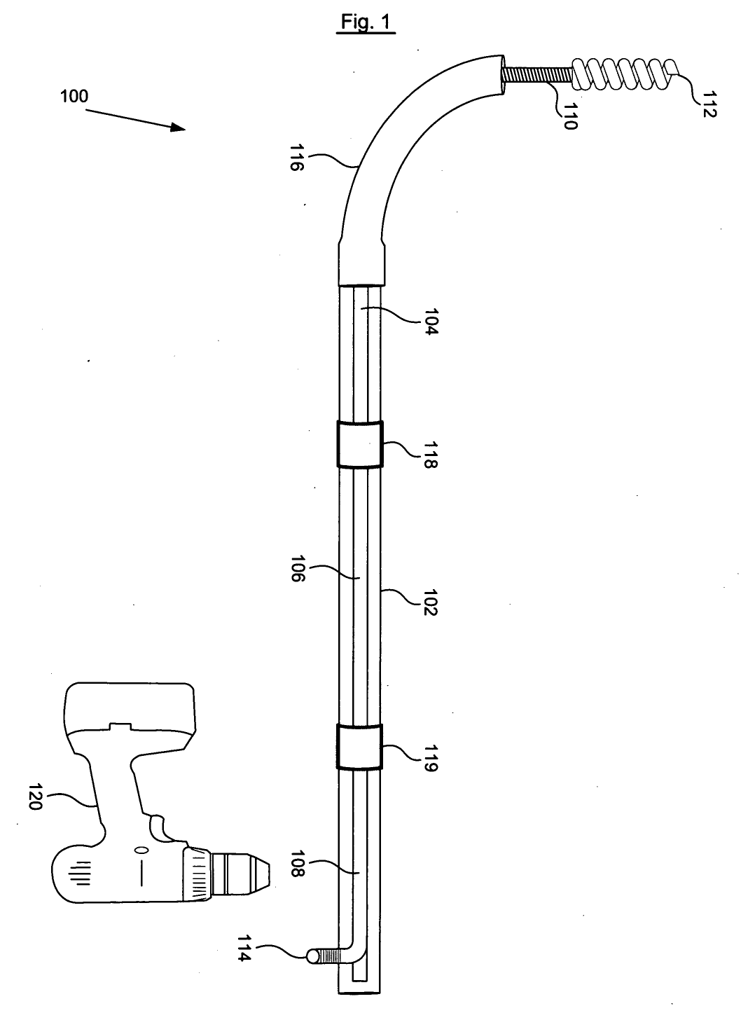

FIG. 1 is schematic diagram of an embodiment 100, such as one or more guide components 102, for example. A guide component may mean one or more components capable of at least in part providing a path, such as for an at least in part flexible component, although claimed subject matter is not limited in this respect. Guide components 102 may comprise one or one or more tubes formed from a suitable materials or combination of materials. For example, guide components 102 may comprise a tube formed from poly vinyl chloride (PVC) plastic, various plastic resins, metal, composites, and/or other materials. Additionally, guide components 102 may further comprise one or more openings, such as openings 104, 106, and/or 108. Embodiment 100 may further comprise an at least in part flexible component 110. In this context, an at least in part flexible component may comprise a component comprising one or more flexible portions which may be capable of removing one or more clogging materials, such as one or more clogs in a plumbing system, although claimed subject matter is not limited in this regard. By way of example, component 110 may comprise a drain snake and/or a drain auger, such as a flexible length of helically coiled metal, although claimed subject matter is not limited in this respect. In this context, a drain auger may comprise a tool and/or device having an at least in part helical shaft or member that may be used for moving loose material, although claimed subject matter is not limited in this regard. Component 110 may comprise a first end 112 and a second end 114, for example. Second end 114 may comprise a shaft, at least in part inserted into a drain auger, although claimed subject matter is in no way limited to this example. Additionally, first end 112 may be configured to receive one or more attachments (not shown). First end 112 may comprise one or more threads for receiving an attachment, though, of course, claimed subject matter is not limited to this illustrative example.

Embodiment 100 may further comprise one or more containment components 118 and/or 119, such as containment bands, for example. In this context a containment component may comprise one or more components for at least in part preventing component 110 from exiting guide component 102 through openings 104, 106, and/or 108, for example. Components 118 and/or 119 may, for example, comprise a ring formed of plastic and/or other materials as described above with regard to guide component 102, sized to fit over guide component 102. Components 118 and/or 119 may, at least in part in response to one or more forces, slide along guide component 102, though, of course, claimed subject matter is not limited in this regard.

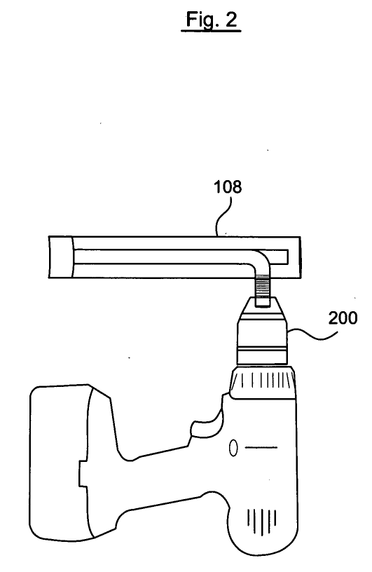

With regard to FIG. 2, a motor powered device 120 may be connected to second end 114 of component 110 for rotating component 110, such as within component 102, for example. Motor powered device 120 may comprise a drill, such as an electrical and/or battery powered drill, for example. In addition, motor powered device 120 may be attached to second end 114 of component 110, such as by tightening a chuck 200 coupled to motor powered device 120 onto second end 114. It should, however, be noted that this is merely an illustrative example relating to a drain cleaner guide and that claimed subject matter is not limited in this regard.

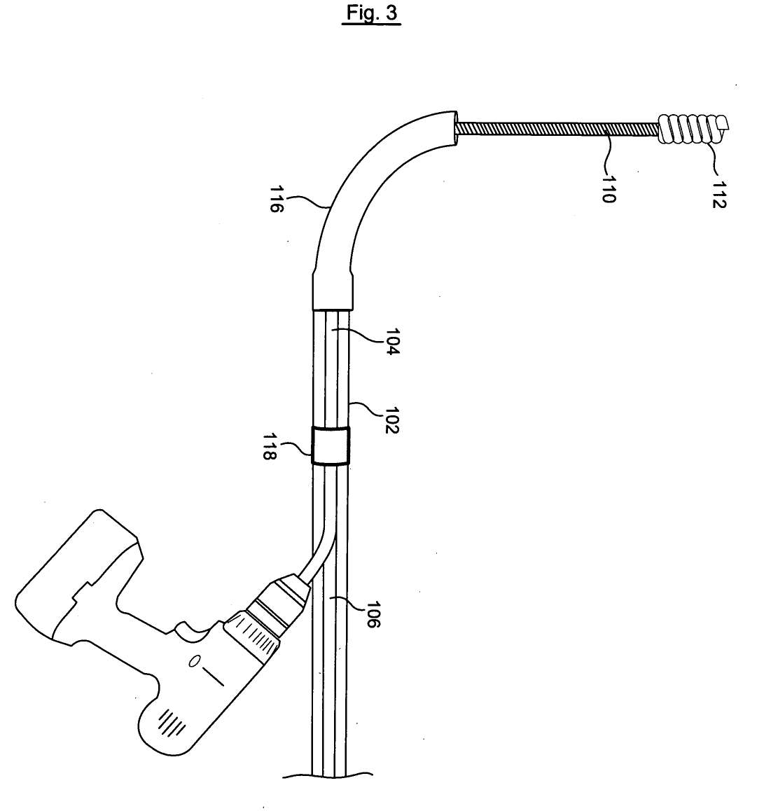

As shown in FIG. 3, motor powered device 120 may be held, such as by a user (not shown) at least somewhat parallel and/or angled relative to component 102, for example. Openings 104, 106, and/or 108 may along with component 102 function to guide and/or convert any force applied to component 110 by the user of motor power device 120 to a force that is at least in part directed parallel to component 102, though, of course, claimed subject matter is not limited to this illustrative example. Component 110 may move within guide component 102, and, when motor powered device 120 is activated, component 110 may rotate within component 102. Guide component 102 may, at least in part, direct component 110 towards a curved end 116, which may, under some circumstances, such as when dealing with a drain having a curved opening, for example, be attached to an end of guide component 102. Guide component 102 may, at least in part, keep component 110 somewhat straight until a portion of component 110 reaches curved end 116, for example. Though, of course, it should be noted that this is merely an illustrative example relating to a guide component and that claimed subject matter is not limited in this regard.

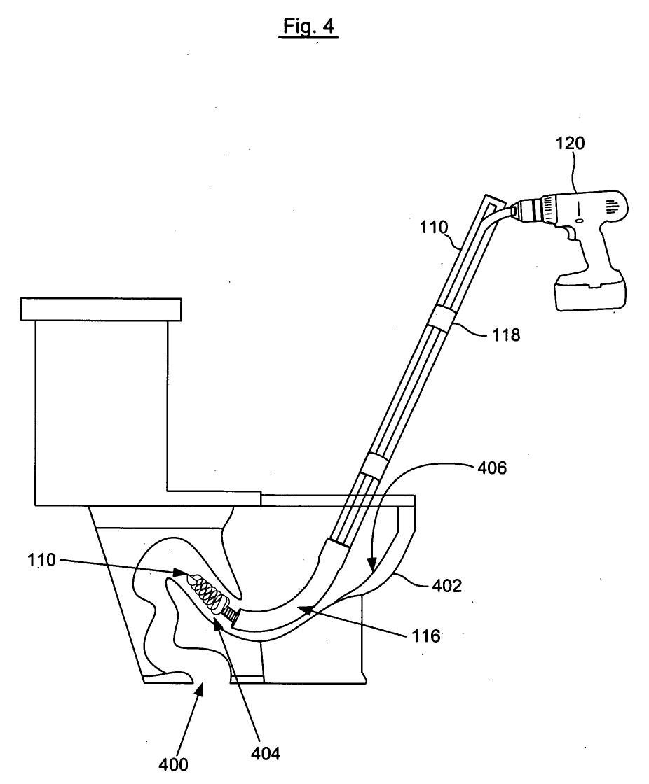

With regard to FIG. 4, embodiment 110 may be at least in part inserted in a plumbing drain 400 of a fixture 402, such as a lavatory drain. In this context, embodiment 100 may be positioned such that curved end 116 may be in at least partial contact with a bent portion 404 of plumbing drain 400, for example. In this way, component 110 may be prevented from contacting fixture 402 in a manner which may scratch a surface, such as surface 406, of fixture 402, for example. For use in other fixtures, such as fixtures where scratching a surface may be less of a concern, such as a sink, curved end 116 may be detached from component 102, though, of course, claimed subject matter is not limited in this regard.

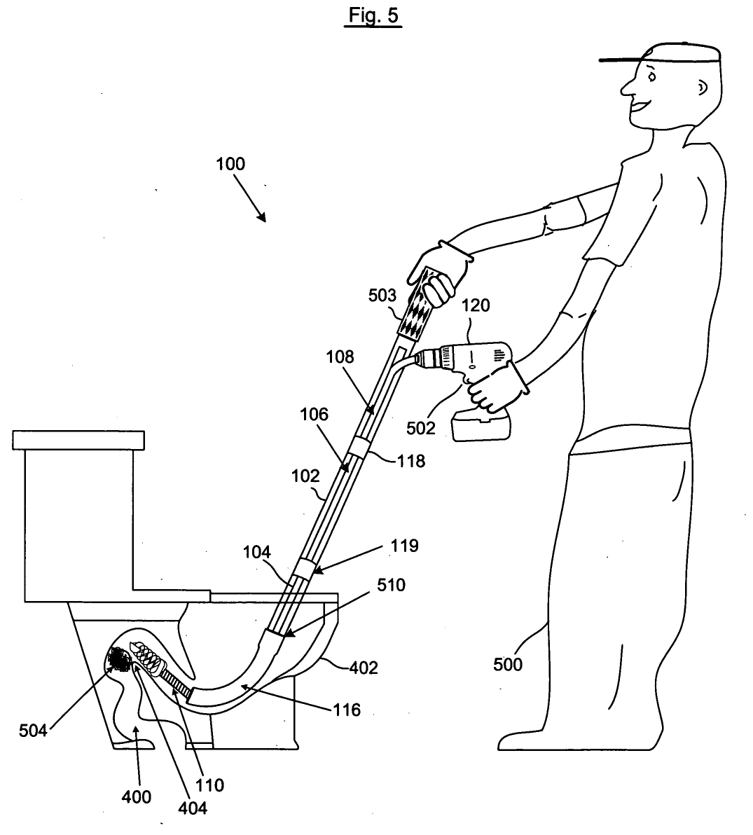

With regard to FIG. 5, a user 500 may hold motor powered device 120, such as with one hand. User 500 may activate motor powered device 120, such as by pressing button 502 on motor powered device 120. Embodiment 100 may, under some circumstances, further comprise a handle 503, though of course claimed subject matter is not limited in this regard. User 500 may hold handle 503 to at least in part stabilize embodiment 100 during operation. Once activated, motor powered device 120 may cause component 110 to spin, such as within component 102, for example. Though, of course, it should be noted that this is merely an illustrative example relating to use of a guide component and that claimed subject matter is not limited in this regard. In addition, user 500 may apply a force to move motor powered device 120 towards curved end 116, which may cause flexible component 110 to move at least in part towards a blockage 504 of drain 400 and/or one or more pipes (not shown) associated with fixture 400. Openings 104, 106, and/or 108 along the length of component 102 may allow component 110 to travel at least in part within component 102 towards blockage 504 until the blockage is dislodged and/or otherwise removed or motor powered device 120 reaches curved end 116 and/or an end 510 of guide component 102, for example. Though, of course, it should be noted that this is merely an illustrative example relating to a guide component and that claimed subject matter is not limited in this regard. In the case of a blockage caused by a hard object, such as a toothbrush, hair brush, deodorizer block or child's toy, for example, embodiment 100 may have advantages such as being easy to use while also having adequate power to break through blockages and/or dislodge objects, for example.

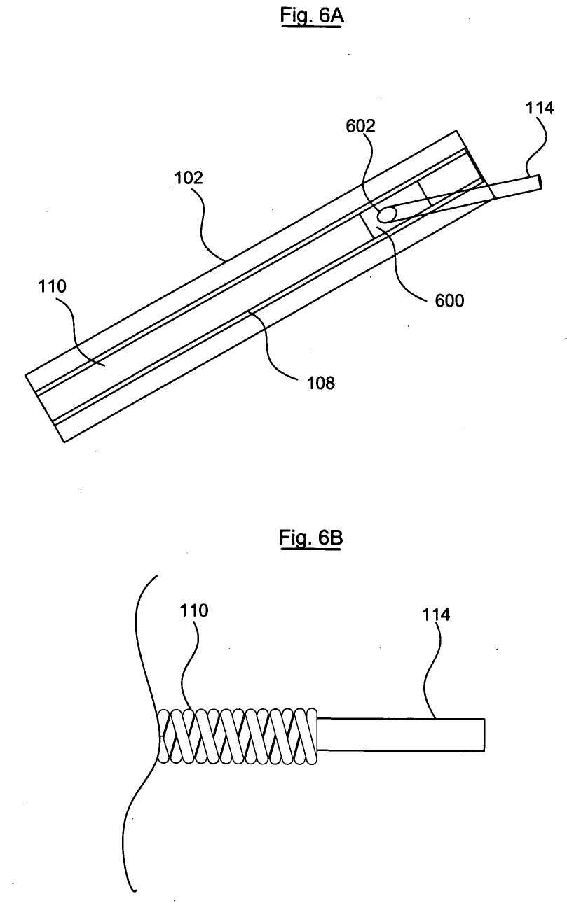

With regard to FIG. 6A, a containment component may additionally comprise a component 600 sized to at least in part fit within openings 104, 106 and/or 108. In this context component 600 may comprise a containment opening 602 sized and/or shaped to receive at least a portion of second end 114 of component 110, for example, though of course claimed subject matter is not limited to this example. Component 600 may move within openings 104, 106, and/or 108 such as in response to a user applying a force to second end 114, such that component 600 may guide component 110, such as when a user applies a force to component 110, towards an opening, such as drain 400. With regard to FIG. 6B, component 110 may, in an embodiment, be sized such that it has a diameter at least in part relatively larger than opening 108, so that a portion of component 110 may not fit through opening 108. In addition, second end 114 may be sized so that it may, at least in part, fit through opening 108 and/or containment opening 602, for example. Though, of course, it should be noted that this is merely an illustrative example relating to component 110 and that claimed subject matter is not limited in this regard. Additionally, component 110 may be sized so that only a portion of component 110, such as second end 114, may fit through openings 104, 106, and/or 108. In addition, component 110 may also be tapered from a diameter at the second end 114, which may be sized to pass through openings 104, 106, and/or 108 for connecting to motor powered device 120.

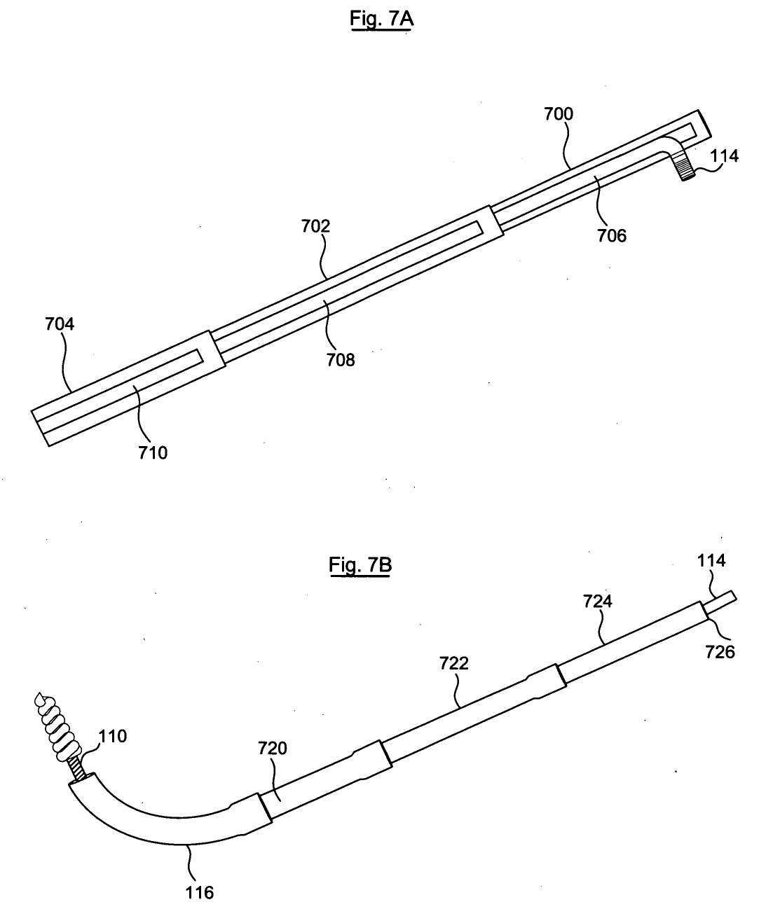

In addition, component 102 may comprise one or more telescoping components 700, 702, and/or 704, which may under some circumstances, have respective openings 706, 708, and/or 710, as shown in FIG. 7A, for example. In this context, one or more telescoping components may comprise components which may be compressed and/or condensed, such as, at least in part, in response to one or more forces applied to the components. By way of example, one or more telescoping components may comprise one or more components sized and shaped such that a first of the one or more components may slide and/or pass within a second of the one or more components, and the second of the one or more components may slide and/or pass within a third of the one or more components, in a manner similar to cylindrical sections of a collapsible hand telescope. Though, of course, it should be noted that this is merely an illustrative example relating to one or more telescoping components and that claimed subject matter is not limited in this regard.

With regard to FIG. 7B, the one or more guide components may comprise at least in part telescoping components 720, 722, and/or 724. In this context, second end 114 may be positioned so as to protrude from an end 726 of telescoping guide component 724, for example. In this way a motor powered device, such as motor powered device 120, may be attached to second end 114. Telescoping guide component 724 may, at least in part in response to a force applied by a user, slide at least in part into telescoping guide component 722, though, of course claimed subject matter is not limited in this regard. Likewise, telescoping guide component 722 may, at least in part in response to a force applied by a user, slide at least in part into telescoping guide component 720. In this manner a user may move at least in part flexible component 110 progressively further into a drain, such as drain 400, for example, by applying a force to a motor powered device attached to second end 114. Though it should be noted that this is merely an illustrative example relating to one or more telescoping guide components and that claimed subject matter is in no way limited in this regard.

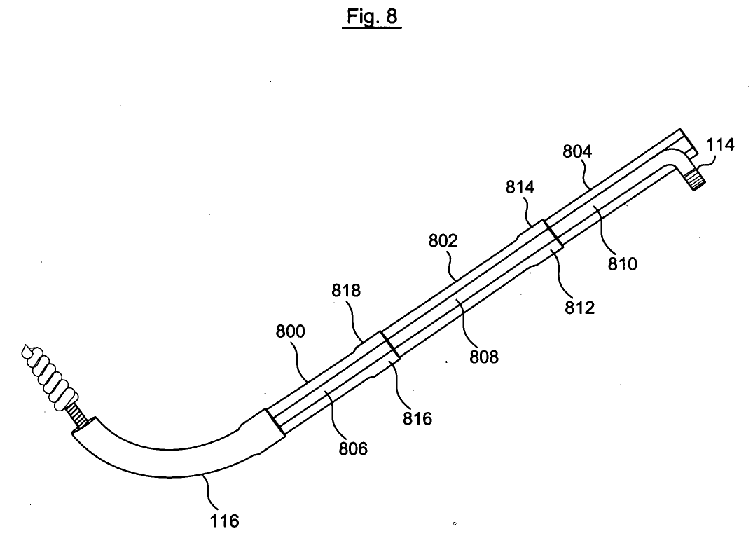

FIG. 8 is a schematic diagram showing one or more removable guide components 800, 802, and/or 804. In this context, removable guide components 800, 802, and/or 804 may comprise one or more tubes having one or more openings, such as openings 806, 808, and/or 810, respectively. By way of illustration, removable guide component 804 may comprise a first end 812 sized and/or shaped to at least in part fit into a second end 814 of removable component 802, for example. Likewise, removable component 802 may comprise a first end 816 sized and/or shaped to at least in part fit into a second end 818 of removable component 800, for example. Openings 806, 808, and/or 810 may, in combination, provide a slot down most and/or all of removable guide components 800, 802, and/or 804. In this way, opening 806, 808, and/or 810 may provide a path for second end 114 as a user applies force to component 110. Though it should be noted that this is merely an illustrative example relating to one or more guide components and, of course, that claimed subject matter is not limited in this regard. In addition, a user may remove one or more removable guide component, such as removable guide component 804, for example, to provide a shorter guide.

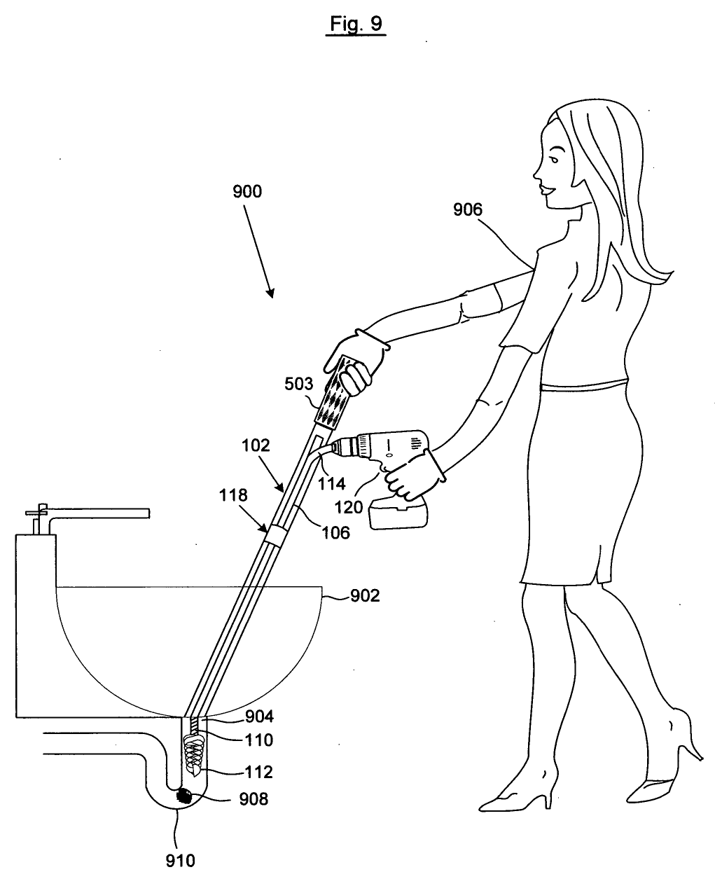

FIG. 9 is a schematic diagram illustrating a usage of an embodiment 900, such as with a sink 902, for example. In this context, embodiment 900 may be substantially similar to embodiment 100 described above, for example. However, embodiment 900 may, in this context, be implemented without curved end 116. In this context, first end 112 of component 110 may be placed at least partially within a drain 904 of sink 902, for example. In response to a force, applied by a user 906, first end 112 of component 110 may move towards a clog 908, which may be lodged or stuck in one or more pipes 910 attached to sink 902. As discussed above, motor powered device 120 may, when activated, cause component 110 to rotate as first end 112 moves towards clog 908. In this manner, user 906 may use embodiment 900 to at least in part dislodge clog 908. Although shown and described in the context of a sink it should be noted that embodiment 900 may be used in a variety of environments, including, but in no way limited to, showers and/or other drains which may be somewhat directly accessed. It should be noted that this is merely an illustrative example relating to a use of an embodiment and that claimed subject matter is not limited in this regard.

It will, of course, also be understood that, although particular embodiments have just been described, claimed subject matter is not limited in scope to a particular embodiment or implementation. In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure the claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. An apparatus comprising:
a guide component having an opening for receiving an end of an at least in part flexible component, said opening operable to at least in part guide movement of said end relative to said guide component, and said guide component operable to at least in part provide a path for said at least in part flexible component.

2. The apparatus of claim 1, and further comprising a retaining component for at least in part maintaining a relative position between said at least in part flexible component, said guide component, and/or said opening.

3. The apparatus of claim 2, and further comprising said at least in part flexible component.

4. The apparatus of claim 3, wherein said at least in part flexible component comprises a flexible drain snake.

5. The apparatus of claim 3, wherein said guide component comprises one or more tubes and wherein said opening comprises one or more lengthwise slots in respective portions of said guide component.

6. The apparatus of claim 3, wherein said guide component comprises a plurality of guide segments, wherein one or more of said plurality of guide segments may be added and/or removed to alter a length of said guide component.

7. The apparatus of claim 3, wherein said guide component comprises one or more telescoping guide segments.

8. The apparatus of claim 3, wherein said end of said at least in part flexible component is capable of being operably connected to a motor powered device.

9. The apparatus of claim 8, wherein said motor powered device comprises an electric drill.

10. The apparatus of claim 9, wherein said electric drill comprises a battery powered drill.

11. The apparatus of claim 3, wherein said retaining component comprises one or more sliding components operable to move along an outside surface of said guide component.

12. The apparatus of claim 3, wherein said retaining component comprises one or more at least in part fixed components at least partially attached at one or more positions on an outside surface of said guide components.

13. The apparatus of claim 3, wherein said retaining component comprises one or more sliding components positioned between one or more sides of said opening.

14. The apparatus of claim 3, wherein said guide component further comprises an at least in part curved component.

15. The apparatus of claim 3, wherein said end of the at least in part flexible component is capable of being operably connected to a manually operated crank.

16. The apparatus of claim 3, wherein a second end of said at least in part flexible component is capable of receiving one or more attachments.

17. The apparatus of claim 16, wherein said one or more attachments comprise one or more heads capable of drilling, boring, polishing and/or honing.

18. The apparatus of claim 3, wherein a diameter of said at least in part flexible component is at least in part tapered such that said first end of said at least in part flexible component fits at least in part within said opening.

19. A system, comprising:
means for at least in part removing clogging materials;
means for guiding the means for at least in part removing clogging materials; and
means for maintaining a relative position between said means for guiding and said means for at least in part removing clogging materials.

20. A method comprising:
moving an at least in part flexible component within a guide component, said guide component having an opening for receiving an end of an at least in part flexible component; and
at least in part with a retaining component, maintaining a relative position between said at least in part flexible component, said guide component, and/or said opening.

21. The method of claim 20, and further comprising rotating the at least in part flexible component.
